(19) United States
(12) Patent Application Publication
(10) Pub. No.: US 2018/0306016 A1
(43) Pub. Date: Oct. 25, 2018

(54) STIMULATION TREATMENT CONDUCTIVITY ANALYZER

(71) Applicant: SCHLUMBERGER TECHNOLOGY CORPORATION, Sugar Land, TX (US)

(72) Inventors: Sergey Safonov, Moscow (RU); Dean Willberg, Tucson, AZ (US); Marina Bulova, Moscow (RU); Oleg Dinariev, Moscow (RU)

(21) Appl. No.: 15/768,643

(22) PCT Filed: Oct. 14, 2016
(86) PCT No.: PCT/US2016/057236

§ 371 Date: Apr. 16, 2018

Related U.S. Application Data
(60) Provisional application No. 62/242,106, filed on Oct. 15, 2015.

(51) Int. Cl. E21B 43/267; G06F 17/50; C09K 8/60; E21B 43/16; G06F 3/0484

(52) U.S. Cl. CPC E21B 43/267; G06F 17/5009; G06F 3/04842; E21B 43/16; C09K 8/604

(57) ABSTRACT

A method can include receiving stimulation treatment scenario definitions for stimulation treatment of a reservoir that includes hydrocarbons; receiving reservoir data; receiving imagery data of a proppant pack; generating a model of the proppant pack based at least in part on the imagery data; simulating physical phenomena associated with a plurality of the stimulation treatment scenarios based at least in part on the model to generate simulation results; and, based at least in part on the simulation results, selecting parameter values for a stimulation treatment.

### BACKGROUND

A stimulation treatment can be a treatment performed to restore or enhance the productivity of a well that is disposed at least in part in a reservoir of a geologic environment. Stimulation treatments can include hydraulic fracturing treatments and matrix treatments. As an example, a fracturing treatment can be performed above a fracture pressure of a reservoir formation and create a conductive flow path between the reservoir and a wellbore. As an example, a matrix treatment can be performed below a reservoir fracture pressure and may aim to restore or enhance permeability of the reservoir (e.g., following damage to a near-wellbore area). As an example, stimulation in a shale gas reservoir can include hydraulic fracturing.

### SUMMARY

A method can include receiving stimulation treatment scenario definitions for stimulation treatment of a reservoir that includes hydrocarbons; receiving reservoir data; receiving imagery data of a proppant pack; generating a model of the proppant pack based at least in part on the imagery data; simulating physical phenomena associated with a plurality of the stimulation treatment scenarios based at least in part on the model to generate simulation results; and, based at least in part on the simulation results, selecting parameter values for a stimulation treatment. A system can include at least one processor; memory accessible by the at least one processor; processor-executable instructions stored in the memory that instruct the system to: receive stimulation treatment scenario definitions for stimulation treatment of a reservoir that comprises hydrocarbons; receive reservoir data; receive imagery data of a proppant pack; generate a model of the proppant pack based at least in part on the imagery data; simulate physical phenomena associated with a plurality of the stimulation treatment scenarios based at least in part on the model to generate simulation results; and, based at least in part on the simulation results, select parameter values for a stimulation treatment. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a process along with graphical representations of a core and core samples;

FIG. 2 illustrates an example of a graphical user interface (GUI) associated with one or more frameworks;

FIG. 3 illustrates an example of a method;

FIG. 4 illustrates an example of a system and associated example methods;

FIG. 5 illustrates an example of a workflow;

FIG. 6 illustrates an example of a workflow;

FIG. 7 illustrates examples of imagery data;

FIG. 8 illustrates an example of a plot;

FIG. 9 illustrates examples of images;

FIG. 10 illustrates an example of a method;

FIG. 11 illustrates examples of plot of information;

FIG. 12 illustrates an example of a plot;

FIG. 13 illustrates an example of a method and an example of a system; and

FIG. 14 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As an example, a framework can include various features for physical and digital rock and fluid analyses, which may aid in creating a reservoir model for simulation of flow performance under multiple production scenarios. Such a framework may utilize physical laboratory measurements to refine reservoir simulation, for example, to enhance determinations as to relative permeability, capillary pressure, net present value, and other parameters associated with reservoir engineering. As an example, fluid can include liquid and/or gas.

As an example, a framework may include one or more features of the COREFLOW™ framework (Schlumberger Limited, Houston, Texas). Such a framework can include instructions that are executable to perform digital simulations. As an example, physical laboratory measurements and/or physical measurements can be utilized to refine digital simulations. As an example, analyses of fluid properties can be performed to create digital fluid models for flow simulation.

While the aforementioned framework refers to “cores”, it can also analyze materials such as proppant as well as interactions between proppant, chemicals, fluids, etc. Proppant can be sized particles mixed with fracturing fluid to hold fractures open after a hydraulic fracturing treatment. Proppant may include naturally occurring sand grains, man-made or specially engineered particles such as, for example, resin-coated sand or high-strength ceramic materials like sintered bauxite. Proppant materials can be sorted for size and sphericity to provide an efficient conduit for production of fluid from a reservoir to a wellbore.

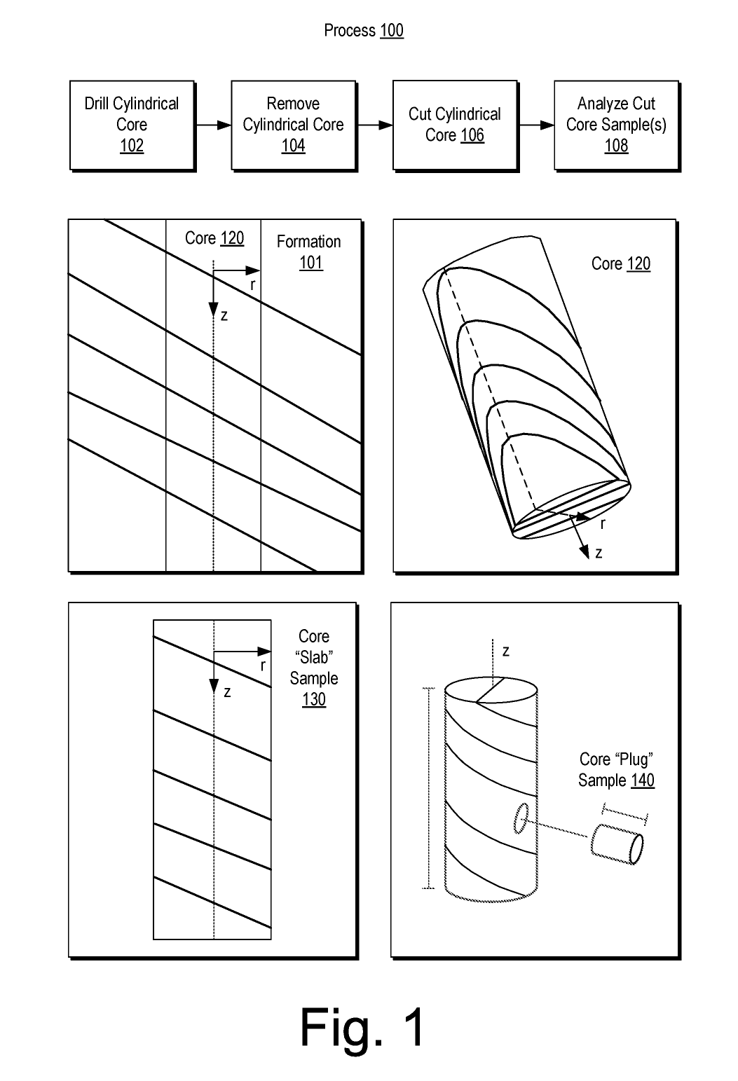

As to core analysis, FIG. 1 shows an example of a process 100 along with graphical representations of a core 120 from a subsurface formation 101. The process includes cutting a cylindrical core 102; removing the cylindrical core 104; cutting (e.g., “slabbing” or “plugging”) the cylindrical core 106, for example, to provide a slab sample (see, e.g., the slab sample 130) and/or one or more plug samples (see, e.g., the plug sample 140); and analyzing the one or more samples 108. As illustrated, a cut parallel to the longitudinal axis can expose a planar surface of the core 120 to provide the slab sample 130, which may then be analyzed (e.g., as to layers, lithology, etc.). As illustrated, a cut into a surface of the core 120 can provide the plug sample 140, which may be within a layer to provide an analysis of a particular layer. As an example, where a core includes a large inclination of the bedding plane, the core plug may be taken in a direction parallel to the bedding plane (e.g., to estimate horizontal and vertical permeability). While slab type and plug type samples are illustrated in FIG. 1, samples may be taken in one or more other angles in relation to a bedding plane (e.g., parallel, perpendicular, 45 degrees, etc.) or manners (e.g., by cutting, etc.).

As an example, a core sample may be analyzed to determine petrophysical data. For example, analyses of a core sample may provide measurements of porosity, grain density, horizontal and vertical permeability, fluid saturation, etc. As an example, a lithologic description may be made as to one or more portions of the core sample. As an example, analyses may provide for a core gamma log. As an example, measurements may be made at various pressure-temperature conditions, including room and/or formation temperature, atmospheric and/or formation confining pressure, etc. Analyses may include routine core analysis (RCA) and/or special core analysis (SCAL). As an example, one or more core analyses may be performed as described in the American Petroleum Institute (API) document “Recommended Practices for Core Analysis” (API RP 40).

Core rock properties provided by logs and sampling can help in reservoir characterization. For example, analyses may determine various reservoir properties of rock.

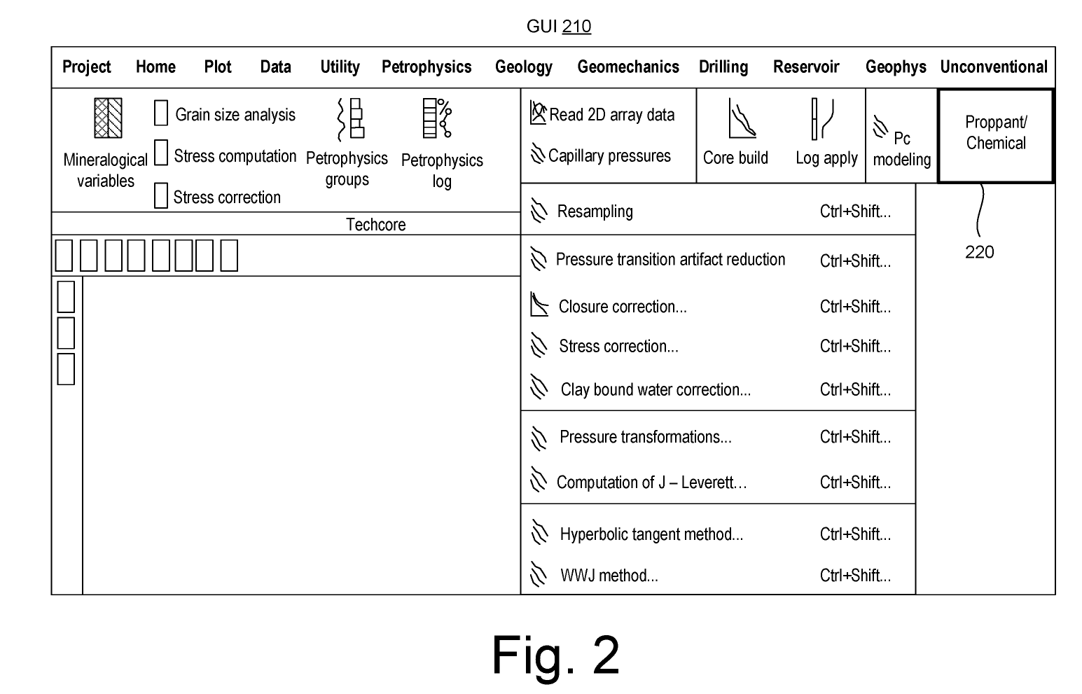

FIG. 2 shows an example of a graphical user interface (GUI) 210 that may be part of a framework executed using one or more processors, memory accessibly the at least one of the one or more processors, etc. As an example, the GUI 210 may be part of a framework such as the TECHLOG™ framework, which may be operatively coupled to the COREFLOW™ framework.

As shown in FIG. 2, the GUI 210 may include various options associated with material analyses, which, in turn, may aid in characterizing materials for use in one or more operations. As an example, a workflow may include one or more worksteps associated with one or more graphical controls of the GUI 210. As an example, a workflow may include performing one or more field operations. As an example, a field operation may include acquiring one or more samples, drilling, injecting fluid, producing fluid, etc. As an example, a field operation may depend in part on results of an analysis of a sample of proppant (e.g., sand, etc.) and one or more chemicals. For example, in FIG. 2, the GUI 210 includes a graphical control 220 for proppant and/or chemical analysis. In such an example, the graphical control 220 may be selected to perform one or more analyses associated with stimulation treatment such as, for example, hydraulic fracturing.

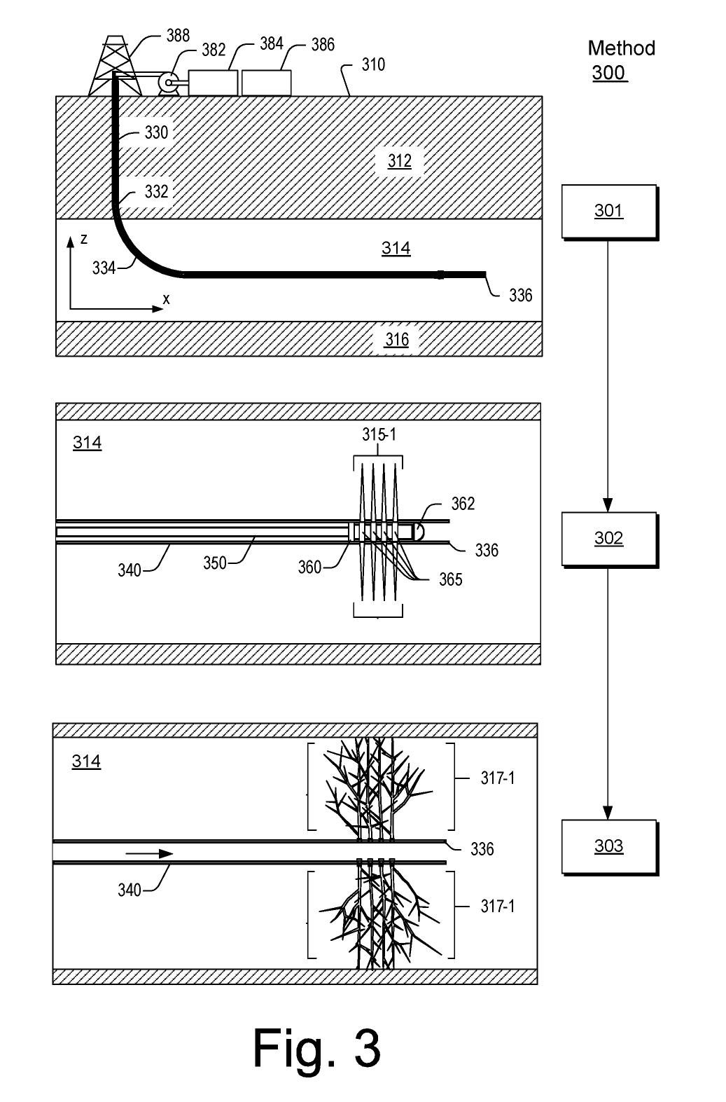

FIG. 3 shows an example of a method 300 that includes generating fractures as part of a stimulation treatment (e.g., hydraulic fracturing). As shown, the method 300 can include various operational blocks such as one or more of the blocks 301, 302, and 303. The block 301 may be a drilling block that includes drilling into a formation 310 that includes layers 312, 314 and 316 to form a bore 330 with a kickoff 332 to a portion defined by a heel 334 and a toe 336, for example, within the layer 314.

As illustrated with respect to the block 302, the bore 330 may be at least partially cased with casing 340 into which a string or line 350 may be introduced that carries a perforator 360. As shown, the perforator 360 can include a distal end 362 and charge positions 365 associated with activatable charges that can perforate the casing 340 and form channels 315-1 in the layer 314. Next, per the block 303, fluid may be introduced into the bore 330 between the heel 334 and the toe 336 where the fluid passes through the perforations in the casing 340 and into the channels 315-1. Where such fluid is under pressure, the pressure may be sufficient to fracture the layer 314, for example, to form fractures 317-1. In the block 303, the fractures 317-1 may be first stage fractures, for example, of a multistage fracturing operation.

In a method such as the method 300 of FIG. 3, it may be desirable that a plug degrades, that a plug seat degrades, that at least a portion of a borehole tool degrades, etc. For example, a plug may be manufactured with properties such that the plug withstands, for a period of time, conditions associated with an operation and then degrades (e.g., when exposed to one or more conditions). In such an example, where the plug acts to block a passage for an operation, upon degradation, the passage may become unblocked, which may allow for one or more subsequent operations.

As an example, a component may be degradable upon contact with a fluid such as an aqueous ionic fluid (e.g., saline fluid, etc.). As an example, a component may be degradable upon contact with well fluid that includes water (e.g., consider well fluid that includes oil and water, etc.). As an example, a component may be degradable upon contact with a fracturing fluid (e.g., a hydraulic fracturing fluid). As an example, a degradation time may depend on a component dimension or dimensions and can differ for various temperatures where a component is in contact with a fluid that is at least in part aqueous (e.g., include water as a medium, a solvent, a phase, etc.).

In a method such as the method 300 of FIG. 3, the fluid introduced into the bore 430 can include proppant and one or more chemicals. Proppant can be sized particles mixed with fracturing fluid to hold fractures open after a hydraulic fracturing treatment. Proppant may include naturally occurring sand grains, man-made or specially engineered particles such as, for example, resin-coated sand or high-strength ceramic materials like sintered bauxite. Proppant materials can be sorted for size and sphericity to provide an efficient conduit for production of fluid from a reservoir to a wellbore.

As to chemicals, one or more of the chemicals of the OpenFRAC fluid family of chemicals (Schlumberger Limited, Houston, Texas) may be utilized. As an example, consider sodium chloride, magnesium chloride, amphoteric alkyl amine, calcium magnesium sodium phosphate, propan-2-ol, acrylamide copolymer, ammonium sulfate, sodium sulfate, potassium chloride, urea, hypochlorous acid, non-crystalline silica, dimethyl siloxanes, silicones, guar gum, hemicellulase (enzyme), boric acid, calcium chloride, etc.

As an example, a fluid can include one or more scale inhibitors that may act to reduce scaling of proppant. As an example, a fluid can provide for crosslinking, gel formation, linear gel formation, slickwater, etc. As an example, one or more chemicals can provide for drag reduction, load-water recovery, and/or formation stabilization. As an example, a chemical may provide for degradation of a component that is intended to be degraded during and/or after an operation.

As an example, a fluid may be formulated to facility transport of proppant (e.g., propping agent) in a fracture, may be formulated to be compatible with formation rock and fluid, may be formulated to generate enough pressure drop along a fracture to create a fracture of a desired width, may be formulated to minimize friction pressure losses during injection, may be formulated using chemical additives that are approved according to local environmental regulations, may be formulated to exhibit controlled-break to a low-viscosity fluid for cleanup after treatment, and may be formulated as to cost-effectiveness.

As an example, one or more workflows may be implemented to optimize formulation of fluid that transports proppant to a fracture such that the proppant forms a proppant pack in the fracture. As an example, a workflow can include determining effective permeability of a proppant pack in a manner that depends on one or more chemicals that are present in hydraulic fracturing fluid.

As an example, viscosity of a fluid may be optimized via chemical composition. As an example, density of a fluid may be optimized via chemical composition. As an example, viscosity and density of a fluid may be optimized via chemical composition. In such examples, optimization can include modeling of a proppant pack and simulating one or more physical phenomena, which can include flow, temperature, reaction rate or rates of various reactions, etc.

As an example, a method may optimize chemistry based at least in part on a type of fracture to be generated. For example, low-viscosity fluids pumped at high rates may aim to generate narrow, complex fractures with low-concentrations of propping agent (e.g., about 0.2 to about 5 Ibm proppant added (PPA) per gallon (e.g., about 24 g/l to about 600 g/l)).

To minimize risk of premature screenout, a pumping rate can be selected to transport proppant over a desired distance, which may be along a horizontal wellbores. For a wide-biwing fracture, fluid can be selected to be of a viscosity for suspension and transport of higher proppant concentrations. Such a treatment fluid may be pumped at a lower pump rate and may create wider fractures (e.g., about 0.5 cm to about 2.5 cm).

Fluid density can affect the surface injection pressure and the ability of the fluid to flow back after treatment. In low-pressure reservoirs, low-density fluids, like foam, can be used to assist in fluid cleanup. Conversely, in certain deep reservoirs (including offshore), higher density fracturing fluids may be utilized.

FIG. 3 also shows a pump 382, pump equipment 384 and monitoring equipment 386 that may be utilized to perform at least a portion of a method such as the method 300 of FIG. 3. As shown in FIG. 3, a rig 388 can be located at a surface location along with the pump 382, the pump equipment 384 and the monitoring equipment 386. As an example, one or more supplies of proppant, chemicals, etc. may be available at a field site where, for example, formulation and mixing may be performed, optionally according to real-time or near real-time analysis of proppant conductivity, etc. As an example, a computer may be operated to output results that can be communicated to a controller and/or an operator to formulate fluid (e.g., including proppant) on site.

As to a fracturing operation, a pressure weight may be of the order of thousands of pounds per square inch (psi). As an example, a flow rate may be of the order of tens of barrels of fluid per minute. As an example, a plurality of pumps may be provided, which may be vehicle-based pumps (e.g., pump trucks).

As to monitoring, a fiber cable may extend into a well where the fiber cable can include one or more individual fibers such as, for example, optical fibers that can provide for frequency and/or temperature sensing. As to frequency, an outer surface that is in fluid may sense characteristics of flow of the fluid in the well. For example, fluid flowing in a conduit (e.g., tubing, a casing, etc.) can result in vortex formation where vortices may shed at one or more frequencies that can impart energy that is sensed by the fiber cable. As an example, a method can include analyzing temperature of fluid as sensed via a fiber cable to determine one or more aspects as to fluid flow in a well. As an example, a fiber cable may be arranged to sense one or more physical phenomena, directly and/or indirectly, such as, for example, strain, temperature, pressure, frequency, vibration, flow, etc. As an example, a fiber cable may be part of a distributed monitoring system (DMS) for distributed pressure sensing (DPS), distributed temperature sensing (DTS), distributed frequency sensing (DFS), etc.

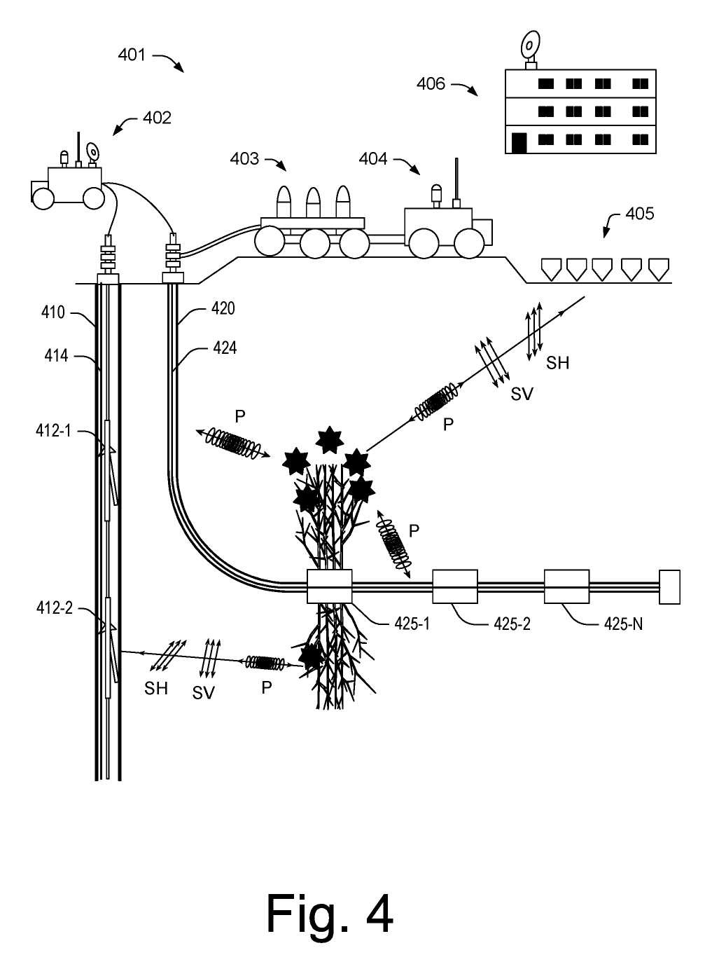

FIG. 4 shows an example of a geologic environment 401 that includes monitoring equipment 402, a pump 403, equipment 404, a seismic sensor or receiver array 405 and a remote facility 406. As shown, various types of communication may be implemented such that one or more pieces of equipment can communicate with one or more other pieces of equipment. As an example, equipment can include geopositioning equipment (e.g., GPS, etc.). As an example, equipment can include one or more satellites and one or more satellite links (e.g., dishes, antennas, etc.).

In the example of FIG. 4, a monitoring well 410 and a treatment well 420 are disposed in the geologic environment 401. The monitoring well 410 includes a plurality of sensors 412-1 and 412-2 and a fiber cable sensor 414 and the treatment well 420 includes a fiber cable sensor 424 and one or more sets of perforations 425-1, 425-2, 425-N.

Equipment in the example of FIG. 4 can be utilized to perform one or more methods. As an example, data associated with hydraulic fracturing events may be acquired via various sensors. As an example, P-wave data (compressional wave data) can be utilized to assess such events (e.g., microseismic events). Such information may allow for adjusting one or more field operations. As an example, data acquired via the fiber cable sensor 424 can be utilized to generate information germane to a fluid flow-based treatment process (e.g., to determine where fluid pumped into a well may be flowing, etc.).

In the example of FIG. 4, the set of perforations 425-1 are shown as including associated fractures and microseismic events that generate energy that can be sensed by various sensors in the geologic environment 401. Arrows indicate a type of wave that may be sensed by an associate sensor. For example, as mentioned with respect to the table or data structure 408, the seismic sensor array 405 can sense P, SV and SH waves while the fiber cable sensor 424 can sense P waves.

As an example, the fiber cable sensor 424 can sense seismic energy as associated with fluid flow, for example, as associated with vortex shedding and/or one or more other phenomena of fluid flow in a well (e.g., a casing, tubing, a conduit, etc.). As an example, such seismic energy may be sensed as seismic traces that include information as to vibrations associated with fluid flow (e.g., fluid flow noise). As an example, the fiber cable sensor 424 may sense one or more of strain and temperature in addition to sensing seismic energy.

As an example, the equipment 402 can be operatively coupled to various sensors in the monitor well 410 and the treatment well 420. As an example, the equipment 402 may be on-site where wires are coupled from sensors to the equipment 402, which may be vehicle-based equipment (e.g., a data acquisition and/or control truck, etc.). As an example, the equipment 404 may control the pump 403 (e.g., or pumps) that can direct fluid into the treatment well 420. For example, a line is shown as a conduit that is operatively coupled between the pump 403 and the treatment well 420.

As an example, information acquired by the equipment 402 may be utilized to control one or more treatment processes controlled by the equipment 404. For example, the equipment 402 and the equipment 404 may be in direct and/or indirect communication via one or more communication links (e.g., wire, wireless, local, remote, etc.). In such an example, information acquired during a treatment process can be utilized in real-time (e.g., near real-time) to control the treatment process. For example, the equipment 402 can acquire data via sensors in the wells 410 and 420 and output information to the equipment 404 for purposes of controlling an on-going treatment process. As an example, such information may be utilized to control and/or to plan a subsequent treatment process, for example, additionally or alternatively to controlling an on-going treatment process.

As an example, a treatment process can include hydraulic fracturing. As an example, acquired data can include microseismic event data. As an example, a method can include determining the extent of rock fracturing induced by a treatment process, which may aim to stimulate a reservoir.

As an example, a method can include hydraulic fracture monitoring (HFM). As an example, a method can include monitoring one or more types of reservoir stimulation processes where one or more of such processes may be performed in stages. As an example, a stage may be of a duration of the order of hours or longer (e.g., several days). As an example, a method can include determining the presence, extent, and/or associated volume of induced fractures and fracture networks, which may be utilized for calculating an estimated reservoir stimulation volume (e.g., ESV) that may assist, for example, in economic evaluation of well performance. As an example, an analysis may aim to increase ESV, for example, a conductivity analysis may output results that can be utilized to estimate ESV and to selected and/or adjust one or more parameters (e.g., parameter values) in an effort to increase ESV with respect to a field operation (e.g., a stimulation treatment).

As an example, real-time data may be rendered to a display (e.g., as a plot, plots, etc.). As an example, real-time data may be assessed in real-time (e.g., near real-time that includes computation and transmission times) during perforation flow for one or more sets of perforations. In such an example, such assessments may allow a treatment process to be optimized during the treatment process in real-time (e.g., near real-time). Such assessments may be utilized for one or more post treatment analyses, for example, to plan, perform, control, etc. one or more future treatments (e.g., in a same well, a different well, etc.).

As an example, a method can include acquiring data germane to flow in one or more wells and/or via perforations in one or more wells. As an example, a method can include acquiring data germane to locating one or more fractures. As an example, a method can include a real-time portion and a post-process portion.

As an example, a framework or frameworks may be utilized prior to, during and/or after performing one or more stimulation operations. For example, the GUI 210 of FIG. 2 may be utilized to control a framework to determine proppant and/or chemical compositions of a hydraulic fracturing fluid prior to, during and/or after performing one or more stimulation operations. As an example, chemical composition may aim to meet one or more criteria. As mentioned, one criterion may be associated with degradation of a degradable component. Other criteria can be associated with flow of proppant, distribution of proppant, packing of proppant, flow of fluid through a porous network formed by proppant, etc.

As an example, a workflow may aim to optimize hydrocarbon reservoir productivity via one or more hydraulic fracturing processes, which may be germane to a value such as ESV. Such a workflow can include comparing analyses for multiple fracture conductivity scenarios. These scenarios can be realized at least in part through multiple numerical simulations of inflow and outflow processes in one or more three-dimensional models of a sand pack (e.g., a proppant pack) and an attached formation representing a portion of a reservoir fracture. Results of such a comparative analysis or analyses can be utilized to determine a selected chemistry, reservoir and operational parameters optimized for a field fracturing operation.

As an example, a method can include improving hydrocarbon reservoir productivity through optimization of fracture conductivity of proppant by evaluating multiple fracture properties through numerical modeling on three-dimensional fracture models.

As an example, one or more operations may aim to comport with API RP 61 “Recommended Practices for Evaluating Short term Proppant Pack Conductivity” and/or API RP 60 “Recommended Practices for testing High-Strength Proppants Used in Hydraulic Fracturing Operations”.

In hydraulic fracture treatment design, choice of proppant can impact overall job economics, treatment operations, and ultimate productivity of a well. A choice of proppant can be based at least in part on a balance between effective fracture length and conductivity against reservoir flow capacity. An accurate assessment of proppant pack conductivity under reservoir stress and flow conditions along with knowledge of reservoir formation deliverability can facilitate hydraulic fracture treatment parameter selection.

A substantial difference can exist between fracture- and proppant pack conductivity where, for example, proppant pack conductivity is estimated via standardized API conductivity tests of proppants in a linear flow cell at a specified pack concentration, closure stress, and temperature.

Proppant pack conductivity can be defined as the product of pack permeability and width. The conductivity can be expected to be dependent on initial grain packing and grain size distribution. And, it can also be expected to change with stress as the packing density and arrangement change and grains tweak. The same packing re-arrangement can also affect the pack width. Conductivity, like permeability, is a representation of a specific packing condition and grain size distribution not an intrinsic material property. To describe conductivity, a statistically relevant number of observations under similar packing conditions and along similar loading paths may be advisable. As an example, observations can be separated into apparent pack width and permeability. As an example, reservoir conditions that determine, at least in part, conductivity of a proppant pack can be simulated. As an example, closure stress, a primary test parameter, tends to be a relevant factor in determining conductivity.

As explained above, a difference between terms is that proppant conductivity is measured in the laboratory test cell, whereas the fracture conductivity is measured in the fracture's performance at reservoir condition in the field. Because fracture conductivity is not measurable until the fracturing treatment is performed, proppant conductivity test results can be used as initial values for fracturing treatments. As an example, a method can include performing digital conductivity analyses for one or more digital proppant pack models. In such an example, the digital proppant pack models can be based on digital imaging, which can be 3D digital imaging. A proppant pack model derived from a 3D digital image (e.g., via image segmentation, pattern recognition, spheroid object fitting, etc.) can be calibrated and, for example, optionally adjusted to account for one or more scenarios without resorting back to physical proppant pack construction and 3D digital imaging. As an example, for a particular fracturing operation, a base model may be constructed and adjusted, optionally statistically. For example, where proppant particles have particular known distributions and may be available from a supplier with different distributions (e.g., particle size, etc.), a base model may be adjusted to generate different models that represent particular proppants as may be available from one or more suppliers. As mentioned, proppant can experience forces when disposed in a fracture. A model can provide for determining how one or more types of proppant respond to such forces. As an example, one or more models can be compared as to response to force, which may be utilized in a screen operation to select a type of proppant for use in a stimulation treatment.

Laboratory conductivity measurements tend to accurately represent a proppant pack under specific test conditions and lab scale. However, as mentioned, the proppant pack being simulated may not accurately represent an entire distribution of proppants in a fracture. Variations of proppant distribution in a fracture can be caused by different factors (e.g., complex fracture geometry) and can tend to result in variations in conductivity. Therefore, when performance of a fracture is evaluated, the average conductivity calculated may differ from that of a laboratory test value. In addition, one or more other damaging mechanisms such as gel damage, multiphase flow below the bubble point in oil wells, geochemical precipitates, and fines may be relevant to one or more operations. Hence, such phenomena can be considered for a proppant pack conductivity test for the fracture conductivity prediction and behavior. As explained, such variations demonstrate why proppant pack conductivity values tend not be, by themselves, a basis for design. As an example, various factors can be utilized in assessing conductivity in addition to proppant pack conductivity.

As an example, one or more parameters associated with fracture geometry may be utilized. In such an example, proppant packs may be constructed and analyzed (e.g., optionally imaged and modeled) based at least in part on one or more fracture geometry parameters (e.g., consider fracture width, variations in fracture width, length of fracture form a wellbore, direction of a fracture with respect to gravity, etc.). As an example, a fracture geometry parameter may be utilized to determine one or more dimensions of a proppant pack and/or how many proppant packs to build (e.g., and image and/or model). As an example, results from proppant pack based analysis may be utilized to adjust one or more fracture geometry parameters and, for example, adjust one or more proppant pack models, etc. Such a process may be repeated until a desired level of correspondence exists between fracture geometry parameters and results from proppant pack based analyses.

As an example, an analysis can include scaling of results from a size of an imaged proppant pack (e.g., of the order of about 5 mm) to a dimension or dimensions of a fracture. In such an example, a method can include determining a scale region. For example, a particular model may be scalable over a distance; whereas, beyond that distance, where variations in a proppant pack in a fracture may be expected, an approach may utilize another model, which itself may likewise be scalable over a distance. As an example, a fracture may be characterized by regions, for example, based on proximity to perforations, proximity to a fracture tip, etc. As an example, regions of a fracture may be characterized by forces that may be experienced over a period of time; where some regions may vary in conductivity more than others. In such an example, one or more models may be utilized to account for regional differences, which may be time dependent (e.g., vary in response to local physical phenomena that may occur in the field).

As an example, a digital conductivity analysis approach can be utilized to determine one or more aspects of a field treatment (e.g., hydraulic fracturing, etc.). As an example, such an approach can assist with design of one or more fracture treatments and/or one or more chemical packages to be delivered in a subterranean environment (e.g., during fracturing generation and/or after fracture generation). As an example, a digital conductivity analysis approach to conductive performance of a hydraulic fracture can consider how “local” conductivity may differ and/or be the same in one or more regions of a hydraulic fracture. As mentioned, an approach may include generating one or more images (e.g., digital images) to guide fluid selection decisions with respect to a particular fracture. As an example, a method can include generating a plurality of different images and synthesizing the different images into a composite image and/or assigning each of the different images to a different region of a fracture. As an example, an interpolation technique may be utilized to bridge images that represent different regions of a fracture. In such an example, a composite image may be formed and, for example, sampled at various regions for purposes of model building (e.g., “sugar-cube” types of models of packed proppant). As an example, one or more models derived at least in part from a plurality of different images may be utilized in a process that can characterize conductivity, particularly in a manner where one or more parameters and/or parameter values may be determined with respect to a field operation (e.g., a stimulation treatment, etc.).

Fracture conductivity may be evaluated from a set several proppant pack conductivity experiments at various conditions that depend upon reservoir deliverability, fracture chemical treatment, embedment, closure stress, reservoir conditions, distribution of proppant in the pack, and the nature of multiphase flow through the pack. As an example, a workflow can include documenting criteria and methodology to allow for accurate comparison of various laboratory proppant pack conductivity results. In such an example, tests can be reliably conducted and documented on potentially different proppant pack samples of various cell loading, stress application, reservoir conations, used chemistry compatibility, and flowing conditions. In such an example, choice of a particular proppant, reservoir fluid composition, based fracturing fluid chemistry and reservoir operational conditions can be based on accurate comparison of results as to performance characteristics. Such an approach allows for analysis of the performance of various proppant materials at multiple fluid, stress, flow conditions, etc. In particular, a workflow can allow for quantitative and accurate comparisons of various scenarios.

Beyond the accurate comparison and analysis of laboratory fracture conductivity measurements, some of the principal physical and petrophysical mechanisms affecting a final proppant pack and thus fracture conductivity can include:

Non-Darcy flow: What is the velocity distribution in the fracture and how does it affect conductivity loss?

Multiphase flow: What does the two- and three-phase relative permeability curve for a proppant pack look like, can it be measured, and how relevant is it?

Multiphase non-Darcy flow: How does multiphase flow in the proppant pack change B, velocity, apparent flowing density, and viscosity? What is the effect on final conductivity?

Gravity and viscous segregation: What the flow path in a proppant pack, how much cleans up, and what the local velocity is? How does this effect conductivity?

Reservoir flow capacity: Does the reservoir determine the amount of conductivity required? Is there ever “too much”?

How does the reservoir geological structure affect the fracture geometry and proppant placement?

As an example, models for fracture cleanup, filter-cake deposition and removal, multiphase flow, regained bulk-pack permeability and non-Darcy flow can be integrated with reservoir transient deliverability to determine a fracture conductivity at reservoir conditions (e.g., a final fracture conductivity over some period of a production curve). As an example, effects of various identifiable damage mechanisms can be taken into account, for example, to economically optimize a stimulation design.

As an example, chemistry and operational conditions can impact fracture conductivity. As an example, a workflow can include analyzing chemistry and/or operational conditions as part of a process to select proppant, chemical(s), fluid, etc. and/or how to deliver such materials.

As an example, a workflow can include numerical modeling for digital fracture conductivity optimization and digital rock concept applications. As reservoir engineering becomes more complex and faces challenges in petrophysics and reservoir engineering, core analysis can benefit from realistically modeled pore geometries and fluid behaviors at pores scales in a timesaving manner. As an example, a workflow can include digital rock analysis which can be integrated with one or more physical and digital core techniques, for example, using the same rock sample(s) for such types of analyses. As an example, via such a workflow, service oil and gas operators may shorten cycle times, understand better increasingly complex reservoirs before making costly field decisions, and maximize both short-term production and long-term recover from oil and gas assets worldwide.

As an example, a workflow can include implementing a framework or frameworks (e.g., consider one or more of the COREFLOW™ framework and the TECHLOG™ framework). The COREFLOW™ framework includes digital rock analysis features for reservoir characterization and hydrocarbon production analysis. An analysis can be implemented in an integrated manner that creates a pore-scale 3D model, which is representative for the reservoir, or several representative pore scale 3D models for heterogeneous reservoir in order to rapidly simulate flow performance under multiple production scenarios and deliver an actionable digital fluid model for making one or more decisions as to one or more stimulation operations. As an example, physical measurements can be utilized to refine a digital model, while digital flow simulation scenarios may guide subsequent lab tests (e.g., in an iterative manner, rather than in a sequential series of steps).

As an example, a workflow can include complex multiphase pore-scale flow simulations via direct hydrodynamic (DHD) simulation. Direct hydrodynamics pore flow simulation can simulate flow in porous media, the results thereof being amenable to decision making for enhancing recovery of hydrocarbons in the field. Simulation can provide reservoir characterization answers germane to reserves estimation, and can offers a considerable level of detail in modeling that can be used to improve production scenario planning decisions for optimized hydrocarbon recovery.

DHD direct hydrodynamic pore flow simulation can include features such as: digital rock models based on the geometry and pore structure of real rocks and digital fluid models; 3D wettability distribution accounting mineralogy and surface chemistry distribution; and setup of various boundary conditions to simulate fluid flow through porous media depending on the considered scenarios and flow conditions.

DHD simulation digitally measures capillary pressure, relative permeability, recovery efficiency, and flow heterogeneity, and combining these simulations with laboratory measurements of the properties can yield enhanced reservoir answers faster than with digital or physical measurements alone.

DHD simulations aim to represent real pore geometries, real fluid properties, and real rock-fluid/fluid-fluid behaviors, without any substantial oversimplification of such components. Through use of DHS simulations, operators can shorten cycle times, understand better increasingly complex reservoirs before making costly field decisions, and maximize short-term production and/or long-term recover from oil and gas assets.

A workflow can include applying enhanced and customized capabilities of digital rock analysis for fracture conductivity modeling to evaluate the optimal parameters and conditions for maximized proppant conductivity, effects of operational stages and efficient fracture performance by screening and comparing various process scenarios by numerical simulations of chemical multiphase flow in a proppant packed fracture.

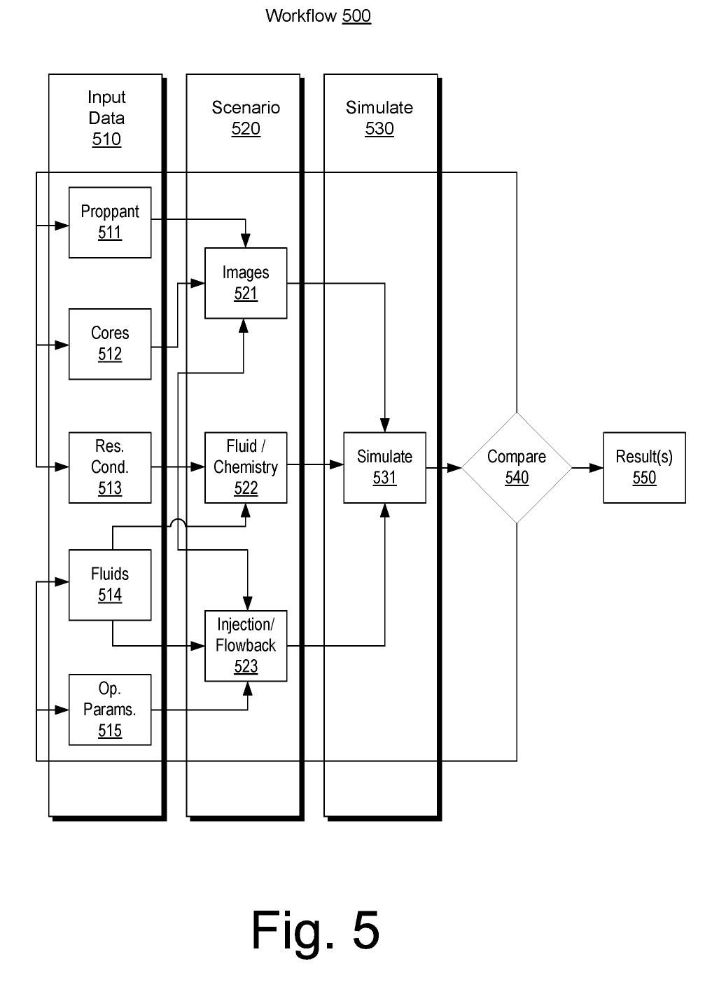

FIG. 5 shows an example of a workflow 500 that includes an input data block 510, a scenario definition block 520, a simulation block 530, a comparison block 540 and a result or results block 550. As shown, the input data block 510 can include input information as to proppant 511, one or more cores 512, reservoir conditions 513, fluids 514 (e.g., reservoir and/or fracturing fluids) and operational parameters 515. The scenario definition block 520 can include information as to one or more images 521 (e.g., 3D images of proppant packs and/or core packs), fluid and chemistry 522 and injection and/or flowback 523. In the workflow 500, the simulation block 530 can include fracture conductivity simulation. In the workflow 500, the result or results block 550, can output a field solution (e.g., an optimal field solution). In such an example, output can include one or more specifications as to performing one or more stimulation operations (e.g., hydraulic fracturing operations).

As an example, a workflow for optimization and efficiency analysis can include stages such as, for example, an input stage for input data and parameter definition which includes initial data about proppant (e.g., type, dimensions, shapes, wettability, mechanical properties, etc.), reservoir formation data and core samples (e.g., geology, mineralogy, flow and petrophysical properties which can be measured and evaluated during well logging operations or laboratory core analysis as well as direct imaging methods such as X-ray micro/nano-tomography, magnetic resonance imaging, etc.), reservoir conditions (e.g., reservoir pressure, temperature, geomechanic stress and strain, anisotropy, etc.), base fracturing and reservoir fluids (e.g., multiple chemical substances used for fracturing operations and reservoir hydrocarbon fluid properties such as thermodynamic, kinetic and rheological behavior, phase and compositional content, geochemistry, etc.), fracturing operation parameters (e.g., time for fracturing operation stages, injection and flowback rates, setup details, etc.).

Another stage can include utilizing the input data and parameters, in a scenario definition stage that provides for constructing a three-dimensional digital rock model, which may be based at least in part on one or more of: pore geometry, mineralogy distribution, wettability and surface chemistry information; digital fluid representation for reservoir hydrocarbon and one or more chemical agents used for the targeted technological fracturing operations; and flowback and injection regimes, for example, as may be defined by treatment pump scheduling to be introduced for numerical simulation and corresponding boundary conditions.

As an example, a workflow can include populating a constructed digital rock domain with multiple fluid, fluid-rock interaction information to direct a hydrodynamic simulator supported by a high performance computing infrastructure (e.g., one or more multi-core processors, etc.). As an example, a simulator can perform modeling of multiphase multicomponent chemical fluid flow scheduled by the defined technological treatment regimes, under defined reservoir conditions and imposed by the defined boundary conditions.

As an example, by controlling the variability of input parameters, proppant properties, fracturing fluid chemistry, reservoir fluid compatibility, reservoir conditions and operational regimes, a quantitative comparing analysis of multiple numerical simulation results can be performed to accurately and quantitatively evaluate the sensitivity of one or more of hydrodynamic, chemical and geomechanic outcome parameters on reservoir characteristics and operational conditions including, for example, fluid loss, efficiency of flowback, formation damage, chemistry compatibility and geomechnical stability.

As a result of a multi-parametric comparative analysis, an optimal chemistry, proppant and regimes for field fracturing operations can be provided for efficient fracture conductivity and hydrocarbon production.

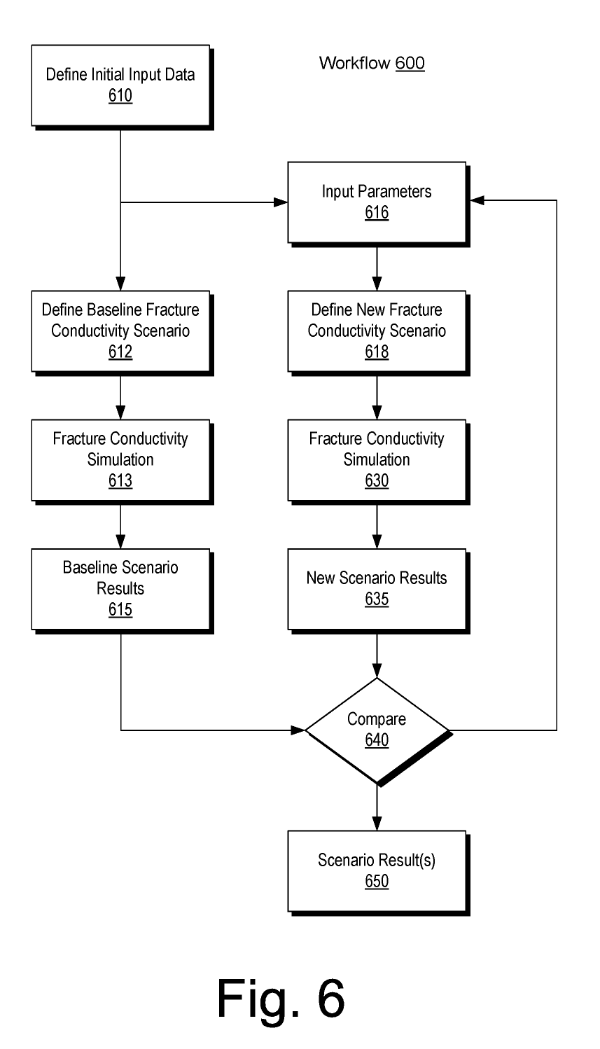

FIG. 6 shows an example of a workflow 600 for fracture conductivity optimization by pore-scale numerical modeling of various digital conductivity scenarios and quantitative comparison analyses to determine an optimal field solution.

As shown in the example of FIG. 6, the workflow 600 includes a definition block 610 for defining initial input data, a definition block 612 for defining a baseline fracture conductivity scenario, a simulation block 613 for simulating fracture conductivity of the baseline fracture conductivity scenario and a results block 615 for outputting results for the baseline scenario that are based at least in part on the simulating. The workflow 600 also includes an input block 616 for inputting parameters (e.g., parameter values), a definition block 618 for defining a new fracture conductivity scenario, a simulation block 630 for simulating fracture conductivity for the new fracture conductivity scenario, and a results block 635 for outputting results for the new fracture conductivity scenario that are based at least in part on the simulating of the simulation block 630. As shown, the workflow 600 includes a comparison block 640 for comparing results of the blocks 615 and 635, for example, to determine an optimal result or results, which may be output per the scenario result or results block 650. As an example, one or more criteria may be applied in the comparison by the comparison block 640 to decide whether one or more additional scenarios are to be considered, for example, by looping back to the input block 616, which can include adjusting one or more parameter values to define another scenario for simulation, etc. In such an example, the comparison block 640 may compare the additional scenario or scenarios to one or more prior scenarios, which can include the baseline scenario.

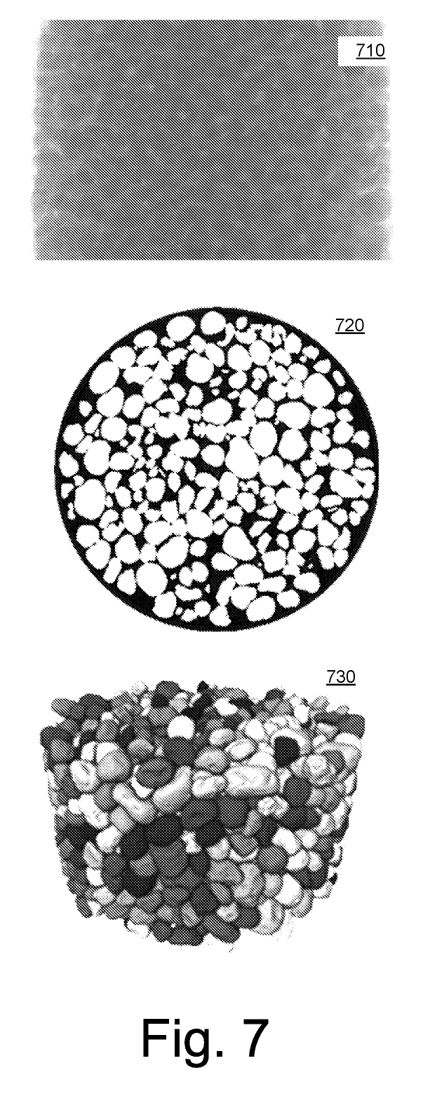

FIG. 7 shows a micro-computerized tomography scan image of proppant as an X-ray shadow projection 710, a reconstructed 2D slice 720 and a reconstructed and labeled 3D image of the sample 730. As shown, various particles can be identified and characterized using a multidimensional imaging approach (e.g., CT, MRI, slicing of bound samples, etc.).

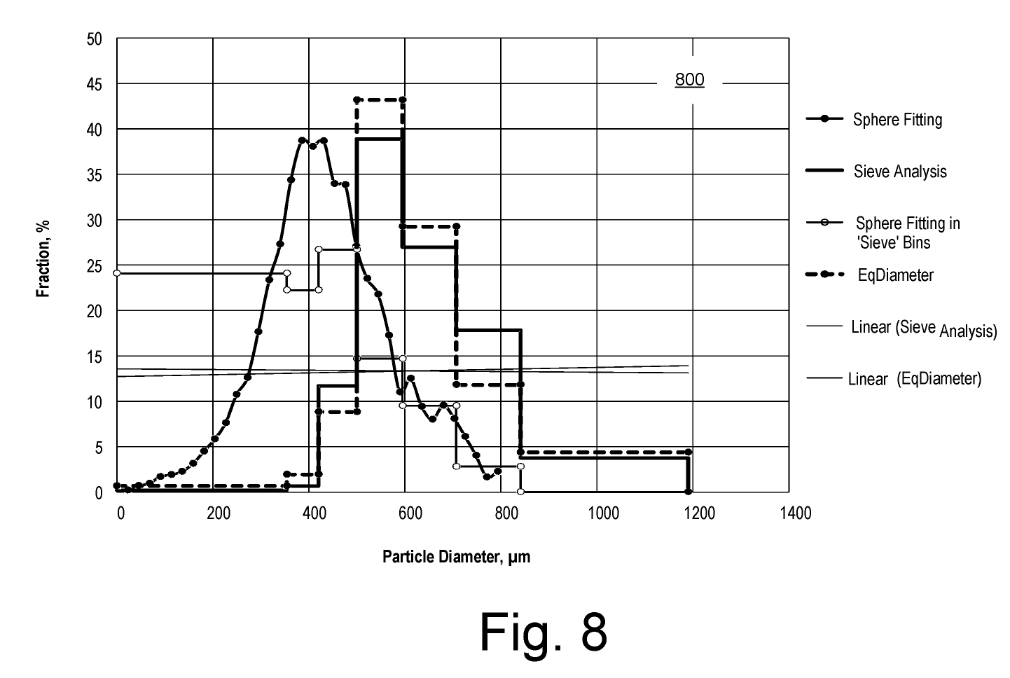

FIG. 8 shows an example plot 800 of proppant grain size distribution derived by different techniques, including laboratory sieve analysis and 3D digital proppant pack image analysis by sphere fitting method and an equivalent diameter method.

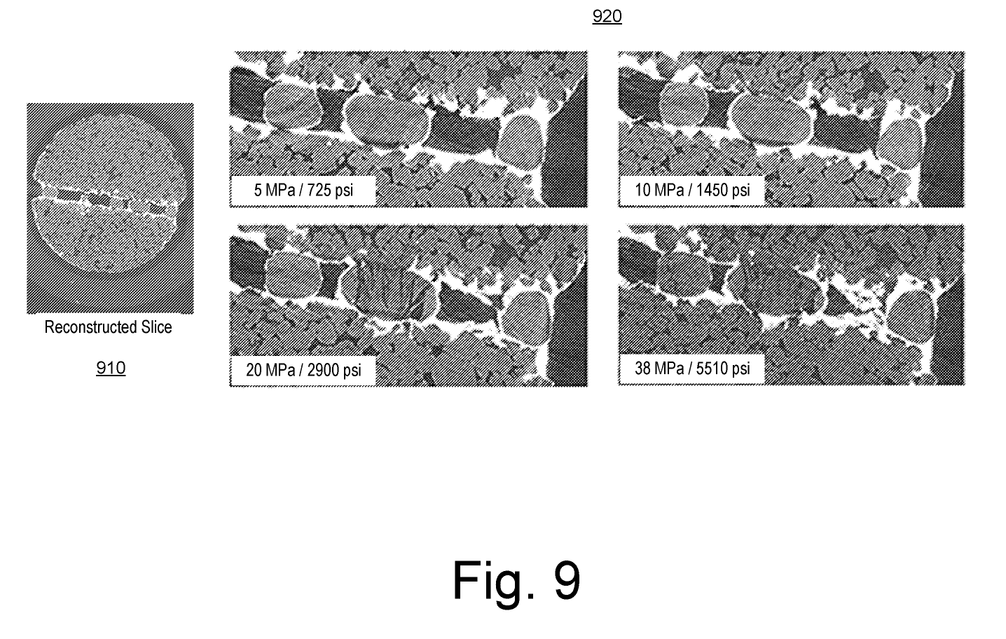

FIG. 9 shows an example of a reconstructed slice 910 and various compressed examples 920 at various stress pressures (sand particles compressed in sandstone at various stress pressures). As shown, pressure range from about 5 MPa to about 40 MPa. As can be seen in FIG. 9, at 38 MPa, spaces between particles are reduced in size compared to 5 MPa.

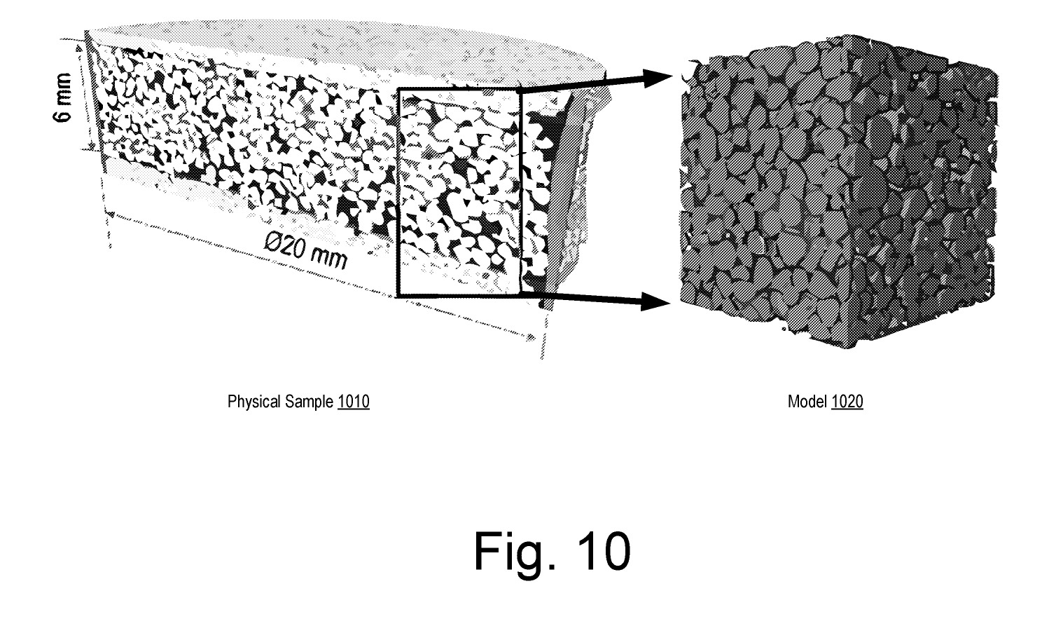

FIG. 10 shows an example of digital model 1020 extraction from a 3D reconstructed image 1010 of an X-ray microCT scanned proppant pack. In the example of FIG. 10, the sample is approximately 6 mm in height and approximately 20 mm in diameter and the digital model 1020 of the order of a few millimeters. As an example, a model may be a “sugar-cube” model, which can be representative of a larger region of a proppant pack (e.g., scale extrapolation). As an example, a fracture width may be of the order of approximately 1 cm.

As an example, a model may consider rheological properties of fluid flow in a proppant pack. For example, fluid can include one or more polymeric materials, one or more surfactants, etc. As mentioned, a fluid may be of a particular composition that can cause degradation of a degradable component. As an example, a fluid may include one or more types of fibers. As an example, one or more materials in fluid may be degradable. As an example, one or more materials in fluid may alter flow in a manner that depends on temperature. For example, viscosity can depend on temperature where a higher temperature results in a lower viscosity.

As an example, flow can be pressure driven flow. As an example, a model can include a Darcy law approximation to flow.

As an example, a workflow can include characterization where fluid, rock and fluid-rock properties are measured. Such characterization can involves PVT data, bulk fluid rheology, fluid-fluid properties (IFT), rock-fluid interactions (e.g., surface energies, composition), and rock morphology. As an example, such a workflow can include simulation, based on the data acquired where one or more digital models are built to explore dynamics of a rock fluid system in porous media representative of the reservoir. As an example, a workflow may include one or more validation procedures. For example, results of numerical simulations may be validated against experimental results of laboratory tests, which may include 2D micromodels with defined geometry and core analysis.

As an example, a validation process can include fluid flow and/or diffusion analysis, which may include NMR, CT or one or more other types of equipment. For example, NMR or MR flow imaging may be utilized (e.g., with or without a contrast agent) or, for example, a radio-opaque dye may be utilized as a contrast agent for X-ray based equipment flow and/or diffusion imaging. As an example, a temperature and/or pressure controlled cell may be utilized that is compatible with NMR and/or X-ray based equipment. As an example, a validation or calibration process may be performed based on such data and may be utilized to understand a range or ranges in which a model may be suitable utilized (e.g., as to simulation of one or more physical phenomena).

As an example, a DHD simulator can be based on a density functional (DF) method applied for multiphase compositional hydrodynamics. Such a simulator can combines continuum fluid mechanics and thermodynamic principles by considering mass, momentum and energy balance together with a diffuse interface description. The diffuse interface approach is a physically consistent and efficient for modeling evolution of fluid-fluid interfaces in multiphase flow. A DHD simulator can combines concepts from physical chemistry, statistical physics and physics of solids with hydrodynamics and takes into account interfacial surface tension, interfacial tension at contact with solid surfaces (wettability), moving contact lines and dynamic changes of topology of interfaces.

A DHD simulator may be implemented for modelling hydrodynamics such as, for example, complex compositional fluids with phase transitions (gas-liquid, liquid-liquid, liquid-solid); flow in complex geometries of boundary surfaces; wettability and adsorption; surfactants, solvents, polymers; complex fluid rheology and presence of mobile solid phase; and thermal effects. Fluid phase behavior, which is traditionally characterized by an equation of state (EoS), can be handled as a thermodynamic fluid model (e.g., specified by Helmholtz free energy functions).

High performance computing with a massively parallel GPU realization of DHD code together with enhanced algorithms of cross-machine and cross-GPU communications interleaved with computations, can allow for modelling several tens of billions (˜10¹⁰) of cells on a medium-sized GPU cluster. Characteristic computational times for complex multiphase flows in representative sub-volumes of digitized rock samples may be of the order of 24 hours while simpler geometries may be of the order of minutes.

As an example, a method may be a real-time or near real-time method. For example, consider equipment as shown in FIG. 4, where information may be gathered in real-time and where one or more simulations may be performed using a digital model of proppant packed into one or more fractures. As an example, validation may occur for one or more simulations based on information sensed before, during and/or after one or more operations. As an example, temperature data acquired may be utilized to adjust one or more models. For example, degradation of materials (e.g., polymers, surfactants, plugs, etc.), may depend on temperature where an Arrhenius equation may be utilized. As another example, viscosity and/or one or more other rheological properties may depend on temperature. As yet another example, reaction rate and rheology may be linked where, for example, a rate of polymer degradation may be coupled to temperature dependent viscosity where degradation decreases viscosity and where an increase in temperature increases the rate of polymer degradation and decreases the viscosity of fluid that includes changing composition of fluid (e.g., per the degradation and/or one or more other effects).

As an example, effective permeability of a proppant pack may be calculated based at least in part on simulation results of a “sugar-cube” type of model. In such an example, effective permeability may be tracked with respect to temperature and/or chemical composition of fluid that is moving in the proppant pack. As an example, where scaling occurs, such a phenomena may act to alter pore size and/or pore structure and/or surface properties of a proppant pack. In such an example, a model may change with respect to time for scaling. As an example, scaling may depend on an amount of fluid flow (e.g., fluid flow velocity), temperature of flowing fluid, viscosity of fluid flowing, chemical reactions in fluid flowing, etc.

As an example, a production decline may be included in a simulation. As an example, a production decline curve may depend on characteristics of a proppant pack in a fracture or fractures. In such an example, an effective permeability of the proppant pack may be taken into account as to its effect on the decline in production. For example, where effective permeability decreases for a proppant pack, it may increase resistance to flow of hydrocarbons through the proppant pack, which, in turn, impacts a production decline curve (e.g., from a drainage area).

As an example, an optimization may aim to provide an optimal effective permeability of a proppant pack in a fracture over a period of time, which may, in turn, provide for a tailored or optimal production curve for a well. In such an example, phenomena such as pressure on a proppant pack due to surrounding formation, due to hydrocarbon reservoir hydrocarbon pressure, etc. may be taken into account.

As an example, where a hydraulic fracturing operation occurs in stages for a well, information acquired during one stage may be utilized to optimize fluid composition and/or proppant for a subsequent stage. For example, fluid flow data, temperature data and/or microseismic data may be analyzed for a stage where a first fluid composition and/or proppant was utilized where results of such an analysis may be utilized to optimize fluid composition and/or proppant for a subsequent stage. As an example, such a workflow may include implementing one or more of the blocks of the workflow 500 of FIG. 5 and/or one or more of the blocks of the workflow 600 of FIG. 6.

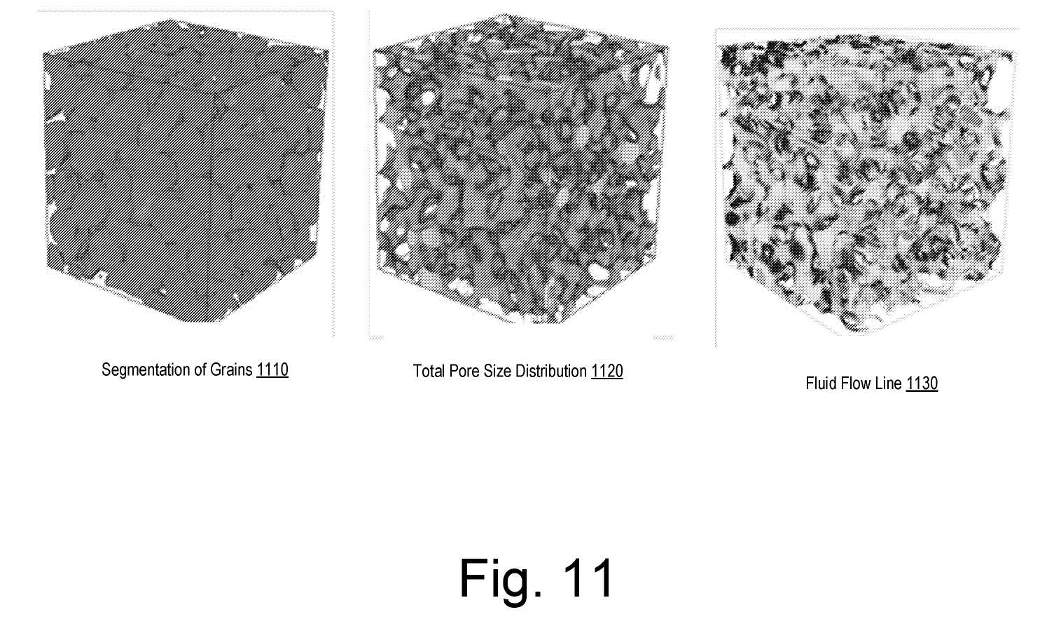

FIG. 11 shows example graphics of a digital proppant pack model segmentation 1110, a pore size analysis 1120 and fluid flow modeling 1130. As shown in FIG. 11, the fluid flow lines of the fluid flow modeling graphic 1130 tend to be quite detailed and varied. Such a graphic demonstrates a level of detail on a scale that is of relevance for proppant in a fracture, for example, for flow of fluid through such proppant (e.g., into and/or out of a reservoir).

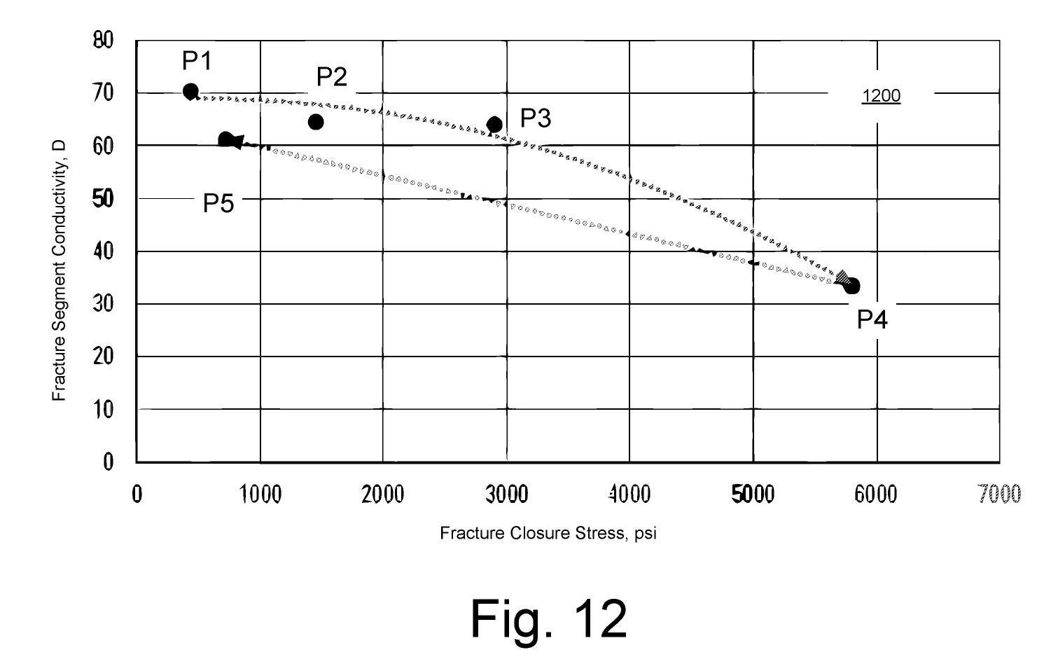

FIG. 12 shows an example plot 1200 of fracture segment conductivity versus fracture closure stress. Data in the plot 1200 include calculated permeability from single-phase fluid flow simulation in a digital proppant pack model as a function of different confining pressures. As mentioned, such pressure may vary with respect to time, for example, in response to one or more physical phenomena, which may depend on fracture and/or reservoir characteristics and, for example, proppant and/or fluid characteristics and/or operational characteristics (e.g., how a treatment is delivered, etc.).

Table 1, below shows various values that correspond to the stage names in the plot 1200.

TABLE 1
Numeric Simulation Data.

| Stage | Confining | Confining | Calculated |
|---|---|---|---|
| Name | pressure, MPa | pressure, psi | permeability, k, D |
| P1 | 3 | 435 | 70.52 |
| P2 | 10 | 1450 | 64.53 |
| P3 | 20 | 2900 | 64.00 |
| P4 | 39 | 5600 | 33.37 |
| P5 | 5 | 725 | 61.33 |

As an example, a method for optimizing reservoir productivity by fracture conductivity analysis can include receiving a three-dimensional (3D) image of a sand pack and an attached formation representing a portion of a reservoir fracture; performing a plurality of simulations on prepared 3D fracture model using multiple scenarios to generate results; performing a comparative analysis of the results to determine a selected chemistry, reservoir and operational parameters optimized for the field reservoir production; and performing a field fracture operation using the selected chemistry and optimal operational parameters. In such an example, a three-dimensional (3D) porous solid image of a sand pack attached to a formation sample can be images generated from the reconstruction of 2D or 3D representation images by X-ray attenuation and diffraction by a sample at laboratory and reservoir environments, can be images obtained by 2D or 3D representation images of nuclear magnetic resonance signal penetration and diffraction by a sample at laboratory and reservoir environments and/or can be images generated by modeling of grain packaging processes and microstructural space generation based on petrographic thin-section analysis under lab and/or reservoir conditions.

As an example, simulations can include one or more of numerical modeling of multiphase and chemical flow for a 3D fracture model to obtain the multiphase fracture conductivity; numerical modeling of multiphase and chemical flow for a 3D fracture model for a fracture conductivity damage analysis for flowback optimization; numerical modeling of grain pack geomechanic stresses under reservoir environment conditions for a 3D fracture model to define the grain packing and crashing characteristics; and numerical modeling of multiphase and chemical flow from a formation sample attached to a sand pack to model the formation deliverability.

As an example, multiple scenarios can include one or more of a plurality of grain arrangements in a 3D fracture model with various parameters of grain geometrical, chemical and mechanical properties; a plurality of formation samples attached to a sand pack for a 3D fracture model with various petrophysical parameters such as porosity, permeability and geomechanic properties; a plurality of fluids of different multiphase multicomponent composition for transport processes through a 3D fracture model with various chemical and operational parameters; chemical effect impact on fluid and solid transport through a 3D fracture model and an attached formation sample to evaluate the pack damage or flow improvement; a plurality of Inflow and outflow multiphase conductivity to optimize the flowback capability of a grain pack; and a plurality of reservoir environment to evaluate the impact of the reservoir conditions on multiphase fracture conductivity

As an example, a comparison analysis or analyses can include one or more of defining the difference between the results obtained by numerical modeling including the initially selected scenario with one or more other selected scenarios; defining the quantitative difference between the results obtained by numerical modeling including the initially selected chemical agent(s) with one or more other selected chemical agent(s); defining the quantitative difference between the results obtained by numerical modeling including the initially selected operational parameters with the other selected operational parameters; defining the quantitative difference between the results obtained by numerical modeling including the initially selected reservoir properties and environment parameters with the other tested reservoir properties and environment parameters; and defining the quantitative difference between the results obtained by numerical modeling including the initially selected sand grain parameters with the other tested grains.

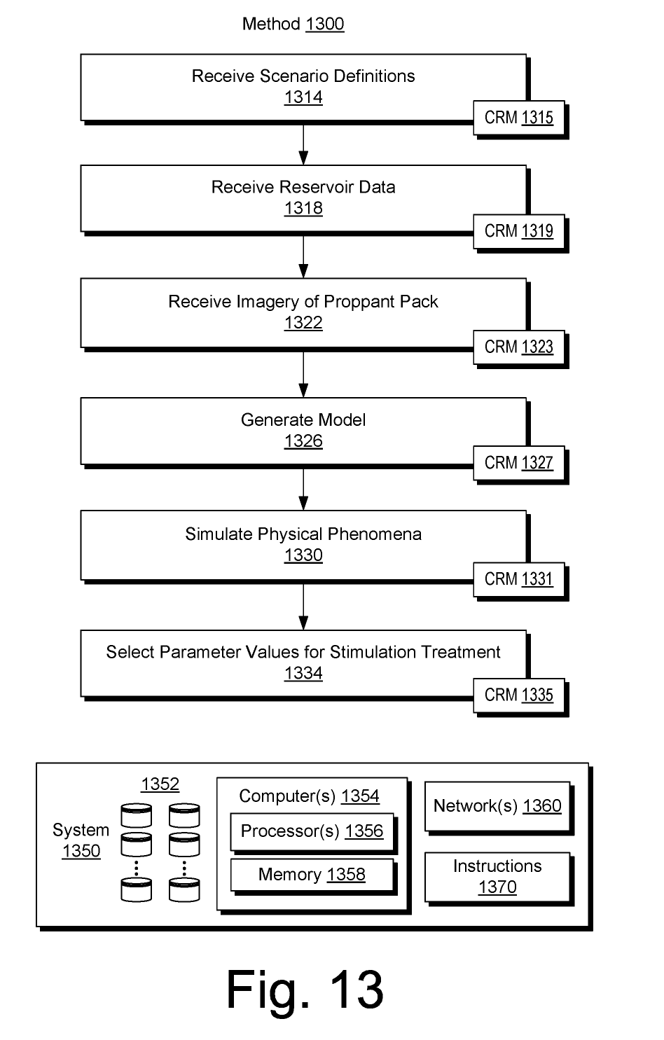

FIG. 13 shows an example of a method 1310 that includes a reception block 1314 for receiving stimulation treatment scenario definitions for stimulation treatment of a reservoir that includes hydrocarbons; a reception block 1318 for receiving reservoir data; a reception block 1322 for receiving imagery data of a proppant pack; a generation block 1326 for generating a model of the proppant pack based at least in part on the imagery data; a simulation block 1330 for simulating physical phenomena associated with a plurality of the stimulation treatment scenarios based at least in part on the model to generate simulation results; and, a selection block 1334 for, based at least in part on the simulation results, selecting parameter values for a stimulation treatment.

The method 1310 is shown in FIG. 13 in association with various computer-readable media (CRM) blocks 1315, 1319, 1323, 1327, 1331 and 1335. Such blocks generally include instructions suitable for execution by one or more processors (or cores) to instruct a computing device or system to perform one or more actions. While various blocks are shown, a single medium may be configured with instructions to allow for, at least in part, performance of various actions of the method 310. As an example, a computer-readable medium (CRM) may be a computer-readable storage medium that is non-transitory and not a carrier wave.

FIG. 13 also shows an example of a system 1350 that includes one or more information storage devices 1352, one or more computers 1354, one or more networks 1360 and instructions 1370. As to the one or more computers 1354, each computer may include one or more processors (e.g., or processing cores) 1356 and memory 1358 for storing instructions, for example, executable by at least one of the one or more processors. As an example, a computer may include one or more network interfaces (e.g., wired or wireless), one or more graphics cards, a display interface (e.g., wired or wireless), etc.

As an example, the instructions 1370 (e.g., stored in memory) can be executable by one or more processors to instruct the system 1350 to perform various actions. As an example, the system 1350 may be configured such that the instructions 1370 provide for establishing a framework or a portion thereof. As an example, one or more methods, techniques, etc. may be performed using the instructions 1370 of FIG. 13.

As an example, instructions can be part of an analysis framework such as, for example, the TECHLOG™ analysis framework and/or the COREFLOW™ framework. As an example, an OCEAN™ framework (Schlumberger Limited, Houston, Tex.) plug-in may be provided that allows interaction between the PETREL™ framework (Schlumberger Limited, Houston, Tex.) and the TECHLOG™ analysis framework and, for example, the VISAGE™ framework (Schlumberger Limited, Houston, Tex.), which can include instructions for modeling fracturing (e.g., hydraulic fracturing). As an example, the MANGROVE™ framework (Schlumberger Limited, Houston, Tex.) may be utilized for simulating behavior in a reservoir.

As to the VISAGE™ framework, it may optionally be coupled to the ECLIPSE™ reservoir simulator and/or the INTERSECT™ reservoir simulator. As an example, in one-way coupling, the reservoir simulator can model flow of fluid in the reservoir and calculates the pressure, temperature, and saturation changes that result. In such an example, the VISAGE™ framework simulator can uses these calculations to perform one or more of 3D static or 4D flow-, pressure-, and temperature-coupled calculations for rock stresses, deformations, and failure. As an example, two-way coupling between simulators can allow for permeability updating of a reservoir model at one or more time-steps, as well as, for example, updating of mechanical properties in a geomechanics model, for example, to account for effects such as changing saturations and water softening. As an example, the VISAGE™ framework may be utilized to model faults, discrete fractures, etc. such that complexity that exists in a geological model may be maintained in a geomechanics analysis.

The MANGROVE™ framework may be operated as a hydraulic fracturing simulator and may be, for example, integrated into one or more seismic-to-simulation workflows (e.g., for conventional and/or unconventional reservoirs) and/or one or more other types of workflows. As an example, the MANGROVE™ package may be implemented to grid and model complex fractures, which may be used for reservoir simulation (e.g., via the ECLIPSE™ framework, the INTERSECT™ framework, etc.).

As an example, one or more hydraulic fracture simulator models may model fracture growth into layers above and/or below a pay zone, for example, along with bi-wing fracture extension. As an example, the MULTIFRAC™ package (Schlumberger Limited, Houston Tex.) may provide for simultaneous multizone fracturing simulations (e.g., with simultaneous initiation and extension of multiple hydraulic fractures).

As an example, a fracture may be simulated and results from such a simulation may be utilized to select imagery and/or one or more models that aim to represent proppant and fluid in the fracture.

As an example, a method can include receiving stimulation treatment scenario definitions for stimulation treatment of a reservoir that includes hydrocarbons; receiving reservoir data; receiving imagery data of a proppant pack; generating a model of the proppant pack based at least in part on the imagery data; simulating physical phenomena associated with a plurality of the stimulation treatment scenarios based at least in part on the model to generate simulation results; and based at least in part on the simulation results, selecting parameter values for a stimulation treatment. In such an example, simulating can include direct hydrodynamic simulation.

As an example, simulating can include direct hydrodynamic simulation based on received imagery data that is composed of multiple images. In such an example, the imagery data (e.g., digital data such as CT, MRI, etc.) may be utilized to construct one or more models, which may be, for example, “sugar-cube” type models that each represent a portion of proppant in a fracture (e.g., in different in regions of a fracture). As an example, analysis of multiple images may be utilized to generate a composite image, which may be utilized to generate one or more models suitable for simulation of fluid flow and/or one or more other physical phenomena.

As an example, a model of a proppant pack can have corresponding physical dimensions, which may be, for example, less than approximately 5 mm. As an example, multiple models of a proppant pack may be used where each of the models can be of corresponding physical dimensions less than approximately 5 mm. As an example, a model can have physical dimensions that correspond to physical dimensions of a proppant pack that has been imaged using an imaging modality such as X-ray micro-CT, micro-MRI, etc. Such imaging modalities can generate images with resolutions that are sub-millimeter such that packed proppant particles and spaces therebetween can be extracted for purposes of model construction.

As an example, a method can include simulating hydraulic fracturing in a reservoir to generate hydraulic fracturing simulation results. In such an example, the method can include selecting at least a portion of the imagery data based at least in part on the hydraulic fracturing simulation results and building one or more models based at least in part on the imagery data. As an example, imagery data may be selected from a library of imagery data that includes, for example, imagery data of various proppant packs.

As an example, simulating can include specifying boundary conditions. For example, consider boundary conditions as to a space and/or a pressure and/or one or more other factors. As an example, spatial boundary conditions can include a fracture width for a fracture in a reservoir.

As an example, a method can include simulating fluid flow in a proppant pack where, for example, the fluid has a chemical composition. In such an example, the chemical composition can include at least one polymer, which may affect rheological properties of the fluid (e.g., viscosity, etc.). As an example, a method can include selecting parameter values for a stimulation treatment by, at least in part, selecting a chemical concentration parameter value for at least one polymer. As an example, a fluid can include one or more surface active agents (e.g., surfactants). As an example, a fluid can include one or more chemicals that are polymeric and surfactants.

As an example, a method can include simulating that includes thermodynamic simulation. As an example, a method can include simulating physical phenomena for a plurality of temperatures and/or simulating the physical phenomena for a plurality of stress pressures. In such an example, the stress pressures can correspond to stress pressures applied to proppant particles of a proppant pack as compressed in reservoir rock (e.g., in a fracture in the reservoir rock).

As an example, a method can include performing a stimulation treatment in the reservoir based at least in part on parameter values from a simulation or simulations. In such an example, a method can include receiving additional reservoir data during performing of the stimulation treatment, simulating physical phenomena based at least in part on a portion of the additional reservoir data, and adjusting at least a stimulation treatment for a subsequent stimulation treatment for the reservoir.

As an example, a parameter value can be a fluid viscosity value. As an example, a parameter value can be a chemical concentration value of an anti-scaling agent. As an example, a method can include modeling production decline for production of hydrocarbons from a reservoir via a well in which a stimulation treatment is to be performed.

As an example, a system can include at least one processor; memory accessible by the at least one processor; processor-executable instructions stored in the memory that instruct the system to: receive stimulation treatment scenario definitions for stimulation treatment of a reservoir that includes hydrocarbons; receive reservoir data; receive imagery data of a proppant pack; generate a model of the proppant pack based at least in part on the imagery data; simulate physical phenomena associated with a plurality of the stimulation treatment scenarios based at least in part on the model to generate simulation results; and, based at least in part on the simulation results, select parameter values for a stimulation treatment.

In such an example, a plurality of processors and a network interface can be included where the network interface is operatively coupled to a network for receipt of real-time reservoir data. As an example, a system can include instructions to render a graphical user interface to a display where the graphical user interface includes a graphical control to initiate the generation of the model of the proppant pack. For example, such a system can include an interface for receiving one or more images of one or more proppant packs. For example, consider an interface that can receive digital CT, MRI and/or other data. As an example, a method can include one or more components (e.g., sets of instructions) for segmenting multidimensional digital image data to construct a model or models. For example, segmenting can include extracting spaces and/or particles from digital image data.

As an example, one or more computer-readable storage media can include computer-executable instructions to instruct a computing system to: receive stimulation treatment scenario definitions for stimulation treatment of a reservoir that includes hydrocarbons; receive reservoir data; receive imagery data of a proppant pack; generate a model of the proppant pack based at least in part on the imagery data; simulate physical phenomena associated with a plurality of the stimulation treatment scenarios based at least in part on the model to generate simulation results; and, based at least in part on the simulation results, select parameter values for a stimulation treatment.

As an example, a method can include receiving stimulation treatment scenario definitions for stimulation treatment of a reservoir that includes hydrocarbons; receiving reservoir data; receiving a fracturing simulation that predicts proppant concentration maps throughout the fracture; using the proppant concentration map to guide selection of proppant pack images; receiving multiple imagery data of a proppant pack; generating a model of the proppant pack based at least in part on the imagery data; simulating physical phenomena associated with a plurality of the stimulation treatment scenarios based at least in part on the model to generate simulation results; and, based at least in part on the simulation results, selecting parameter values for a stimulation treatment. In such an example, the fracturing simulation (e.g., via VISAGE™ framework, MANGROVE™ framework, etc.) may provide a basis for proppant pack construction and/or proppant pack image selection. As an example, a library of models may be generated for a variety of scenarios where a fracturing simulation may generate results that can be associated with one or more models of the library. For example, results may be rendered to a display and regions of a fracture associated with one or more models from a library. In such an example, digital simulations may be performed using one or more of the models where results therefrom may be utilized to optimize one or more stimulation treatments.

The term “circuit” or “circuitry” can include all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Circuitry can include one or more computer-readable media that include computer-executable instructions to instruct a computer to perform one or more actions. The term “computer-executable instructions” includes processor-executable instructions, whether a processor is a central processor, a graphics processor or other type of processor. Instructions stored on a computer-readable medium may be software (e.g., instructions for telling a computer, computing device, etc., what to do and how to do it). A computer-readable medium may be a storage device such as memory, an optical storage device, etc. Such a storage device may store instructions and optionally other information (e.g., data, etc.) in a non-transitory manner.

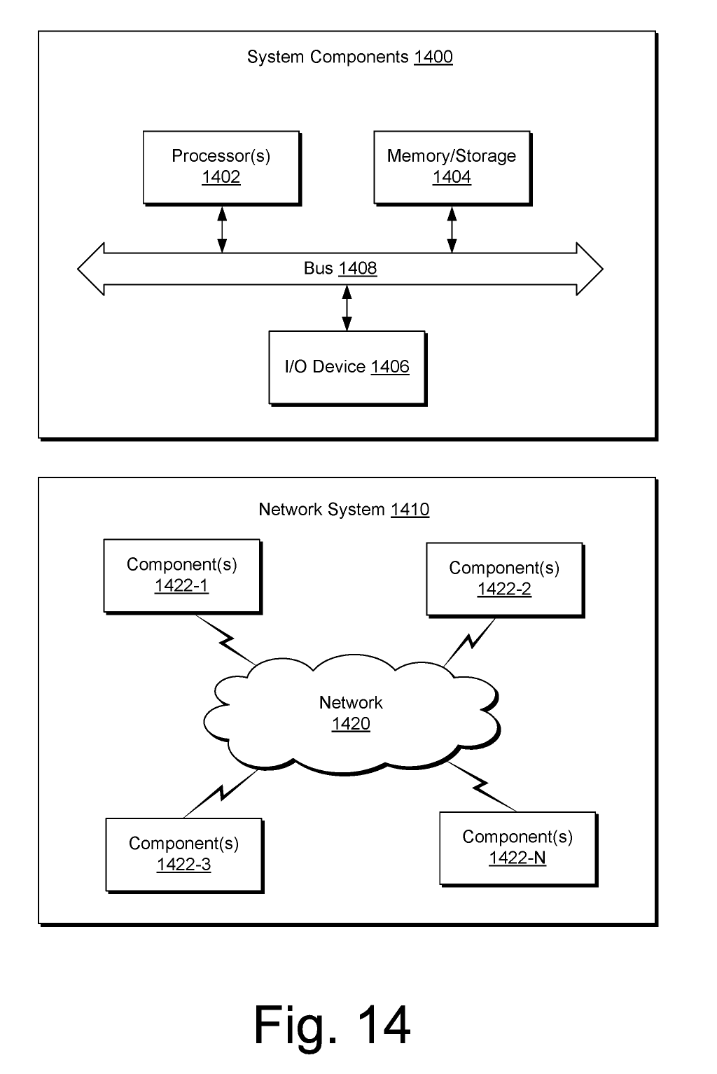

FIG. 14 shows components of an example of a computing system 1400 and an example of a networked system 1410. The system 1400 includes one or more processors 1402, memory and/or storage components 1404, one or more input and/or output devices 1406 and a bus 1408. In an example embodiment, instructions may be stored in one or more computer-readable media (e.g., memory/storage components 1404). Such instructions may be read by one or more processors (e.g., the processor(s) 1402) via a communication bus (e.g., the bus 1408), which may be wired or wireless. The one or more processors may execute such instructions to implement (wholly or in part) one or more attributes (e.g., as part of a method). A user may view output from and interact with a process via an I/O device (e.g., the device 1406). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1410. The network system 1410 includes components 1422-1, 1422-2, 1422-3, . . 1422-N. For example, the components 1422-1 may include the processor(s) 1402 while the component(s) 1422-3 may include memory accessible by the processor(s) 1402. Further, the component(s) 1422-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

Bibliography of documents incorporated by reference herein:
1. Economides, Michael J and Nolte, Kenneth G. Reservoir Stimulation in Petroleum Production, Wiley (2000).
2. Inside the Rock. Alexander Nadeev, Denis Klemin. 2014, GEO ExPro, pp. 32-33.
3. Digital Core Flow Simulations Accelerate Evaluation of Multiple Recovery Scenarios. Andersen, Mark. 2014, World Oil, pp. 50-55.
4. Integrated Rock and Fluid Analysis Services Aim to Improve Enhanced Oil Recovery. Andersen, Mark. 2014, Offshore.
5. Rock Analysis Enters New Era. Andersen, Mark. 2014, Offshore Engineer, pp. 42-43.
6. CoreFlow Digital Rock and Fluid Services. [Online] http://www.slb.com/services/characterization/petrophysics/core_pvt_lab/coreflow.asp x.
7. A. Demianov, O. Dinariev and N. Evseev. Introduction to the Density Functional Method in Hydrodynamics. ISBN 978-5-9221-1539-1: Schlumberger, 2014.
8. Direct Hydrodynamic Simulation of Multiphase Flow in Porous Rock. D. Koroteev, O. Dinariev, N. Evseev, D. Klemin, A. Nadeev, S. Safonov, O. Gulpinar, S. Berg, C. van Kruijsdijk, R. Amstrong, M. T. Myers, L. Hathon, H. de Jong. 2013. Society of Core Analysts. pp. 2013-014.
9. Direct Hydrodynamic Simulation of Multiphase Flow in Porous Media. D. Koroteev, O. Dinariev, O. Evseev, D/ Klemin, A. Nadeev, S. Safonov, O. Gurpinar, S. Berg, C. van Krijsdijk, R. T. Amstrong, M. T. Myers, L. Hathon and H. de Jong. 4, s.l. : Petrophysics, 2014, Petrophysics, Vol. 55, pp. 55 (4), 294-303. 294-303.

What is claimed is:

1. A method comprising:
receiving stimulation treatment scenario definitions for stimulation treatment of a reservoir that comprises hydrocarbons;
receiving reservoir data;
receiving imagery data of a proppant pack;
generating a model of the proppant pack based at least in part on the imagery data;
simulating physical phenomena associated with a plurality of the stimulation treatment scenarios based at least in part on the model to generate simulation results; and
based at least in part on the simulation results, selecting parameter values for a stimulation treatment.

2. The method of claim 1 wherein the simulating comprises direct hydrodynamic simulation.

3. The method of claim 1 comprising simulating hydraulic fracturing in the reservoir to generate hydraulic fracturing simulation results and selecting at least a portion of the imagery data based at least in part on the hydraulic fracturing simulation results.

4. The method of claim 1 wherein the model of the proppant pack comprises dimensions less than approximately 5 mm.

5. The method of claim 1 wherein the simulating comprises boundary conditions wherein the boundary conditions comprise a fracture width for a fracture in the reservoir.

6. The method of claim 1 wherein the simulating simulates fluid flow in the proppant pack. The method of claim 6 wherein the fluid comprises a chemical composition.

8. The method of claim 7 wherein the chemical composition comprises at least one polymer and wherein the selecting parameter values for a stimulation treatment comprises selecting a chemical concentration parameter value for the at least one polymer.

9. The method of claim 1 wherein the simulating comprises thermodynamic simulation.

10. The method of claim 1 wherein the simulating comprises simulating the physical phenomena for a plurality of stress pressures.

11. The method of claim 10 wherein the stress pressures correspond to stress pressures applied to proppant particles of the proppant pack as compressed in reservoir rock.

12. The method of claim 1 comprising performing the stimulation treatment in the reservoir based at least in part on the parameter values.

13. The method of claim 12 comprising receiving additional reservoir data during the performing of the stimulation treatment, simulating physical phenomena based at least in part on a portion of the additional reservoir data, and adjusting at least a stimulation treatment for a subsequent stimulation treatment for the reservoir.

14. The method of claim 1 wherein the parameter values comprise a fluid viscosity.

15. The method of claim 1 wherein the parameter values comprise a chemical concentration of an anti-scaling agent.

16. The method of claim 1 comprising modeling production decline for production of the hydrocarbons from the reservoir via a well in which the stimulation treatment is to be performed.

17. A system comprising:
at least one processor;
memory accessible by the at least one processor;
processor-executable instructions stored in the memory that instruct the system to:
receive stimulation treatment scenario definitions for stimulation treatment of a reservoir that comprises hydrocarbons;
receive reservoir data;
receive imagery data of a proppant pack;
generate a model of the proppant pack based at least in part on the imagery data;
simulate physical phenomena associated with a plurality of the stimulation treatment scenarios based at least in part on the model to generate simulation results; and
based at least in part on the simulation results, select parameter values for a stimulation treatment.

18. The system of claim 17 comprising a plurality of processors and a network interface that is operatively coupled to a network for receipt of real-time reservoir data.

19. The system of claim 17 wherein the instructions comprise instructions to render a graphical user interface to a display wherein the graphical user interface comprises a graphical control to initiate the generation of the model of the proppant pack.

20. One or more computer-readable storage media comprising computer-executable instructions to instruct a computing system to:
receive stimulation treatment scenario definitions for stimulation treatment of a reservoir that comprises hydrocarbons;
receive reservoir data;
receive imagery data of a proppant pack;
generate a model of the proppant pack based at least in part on the imagery data;
simulate physical phenomena associated with a plurality of the stimulation treatment scenarios based at least in part on the model to generate simulation results; and
based at least in part on the simulation results, select parameter values for a stimulation treatment.
